(19) United States
(12) Patent Application Publication
(10) Pub. No.: US 2006/0104801 A1
(43) Pub. Date: May 18, 2006

(54) Method for transporting bodywork panels of a vehicle and corresponding transport device

(76) Inventor: Harald Wolf, Gaggenau (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/539,941

(22) PCT Filed: Dec. 9, 2003
(86) PCT No.: PCT/EP03/13919

§ 371 Date: Jun. 17, 2005

(30) Foreign Application Priority Data
Dec. 19, 2002 (DE) 102 59 974.2

(51) Int. Cl. B65G 1/10

(52) U.S. Cl. 414/810

(57) ABSTRACT

The method is used for transporting bodywork panels (12) of a vehicle by means of an endless transport device (10), equipped with a plurality of carrier units (16) that are spaced at intervals in the transport direction (14). In this case, provision is made for an associated group (18) of panels to be stacked on at least one carrier unit (16), for the group (18) of panels to be transported as far as a panel removal station (20) and in each case for an individual bodywork panel (12) to be removed by a panel separation device (22) at the panel removal station (20).

### BACKGROUND OF THE INVENTION

1. Field of the Invention

The invention relates to a method for transporting bodywork panels of a vehicle by means of an endless transport device, equipped with a plurality of carrier units that are spaced at intervals in the transport direction, according to the preamble of claim 1. Furthermore, the invention relates to a transport device for implementing the method, corresponding to the preamble of claim 7.

2. Related Art of the Invention

Methods and transport devices of the type mentioned at the beginning are known. DE 198 50 964 A1 discloses a device for transporting workpiece parts, which, in order to ensure defined support for the workpieces, has part-specific templates, on which the workpieces can be deposited. The workpieces are in particular bodywork panels of a vehicle.

### SUMMARY OF THE INVENTION

It is an object of the invention to propose a method and a suitable transport device which permit the transport of bodywork panels which is beneficial to operation.

In order to achieve the object, a method having the features of claim 1 is proposed. The method according to the invention is distinguished by the fact that an associated group of panels is stacked on at least one carrier unit, the group of panels is transported as far as a panel removal station and in each case an individual bodywork panel is removed by a panel separation device at the panel removal station. On account of the formation of groups of panels, it is possible to use the endless transport device as an intermediate store in addition to its transport function. By this means, transport and intermediate storage of bodywork panels which is flexible and easy to operate is ensured. Thus, the method permits the integration of two devices (transport device, storage device) that are otherwise constructionally and functionally completely separate from each other to form one multifunctional constructional unit. The intermediate storage capacity of the transport device can be influenced, amongst other things, by the predefinable number of carrier units.

Advantageously, the bodywork panels of a respective group of panels are arranged stacked on edge in the carrier unit at a panel group formation station. By means of stacking the bodywork panels on edge, the stacking length taken up in the transport direction can be matched in a variable manner to the transport and/or intermediate storage task respectively to be fulfilled. In this case, the carrier units can, if appropriate, also transport or intermediately store groups of panels having a different number of bodywork panels.

The group of panels is preferably built up in the carrier unit by means of the successive deposition of individual bodywork panels. In this case, the individual bodywork panels can be deposited in the carrier unit manually or in an automated manner, forming the group of panels. In this way, it is possible to match the intermediate storage capacity of the transport device to the respective transport operating situation at that time. Thus, in the case of a relatively low demand for bodywork panels, a maximum storage capacity of the transport device can be used, since there is sufficient time available for the panel group formation and, therefore, the carrier units in each case can be filled with a maximum number of bodywork panels. By contrast, at higher transport speeds of the transport device, the respective carrier unit capacity for bodywork panels to be accommodated may possibly not be utilized to the maximum, since there is not sufficient time for the formation of a group of panels of maximum size.

According to a preferred design variant, the group of panels is transported from the panel group formation station as far as the panel removal station in a transport direction that extends obliquely upward. This makes it possible to use a relatively small overall volume both for the transport function and for the intermediate storage function. Given a suitable configuration of the carrier units, in the case of a transport device running obliquely upward, automatic centering of a respective group of panels within the transport device can be achieved. The panel group formation station and the panel removal station of the transport device are located at different levels, so that the panel group formation device and the panel separation device can, if appropriate, be constructed differently from each other.

The respective group of panels is advantageously transported by means of the transport device during a predefinable cycle time, the cycle time depending on the required panel separation time of a complete group of panels respectively located at the panel removal station. The transport and intermediate storage functions of the transport device are thus always coordinated with each other in an optimized way, so that bottleneck situations in relation to a sufficient provision of panels can virtually be ruled out.

In order to achieve the object, a transport device having the features of claim 7 is also proposed. The transport device according to the invention is distinguished by the fact that the respective carrier unit has at least one carrier element projecting substantially at right angles to the transport direction. In this case, the carrier element is used as a support delimiting the carrier unit for a group of panels to be formed.

Advantageously, the position of the carrier element can be adjusted in the transport direction and/or transversely with respect to the transport direction. Furthermore, the number and/or the design construction of the carrier elements used in a carrier unit can be varied as a function of the geometric shape of a bodywork panel. In this way, correct and secure holding of a group of panels in a carrier unit of the transport device is ensured, it being possible for different transport requirements to be fulfilled by means of the transport device by matching the carrier elements to the respective geometric shape of a bodywork panel.

According to a preferred embodiment, the transport device is constructed as a chain transport device. Transport devices of this type are known per se and are particularly suitable for the cyclic transport of workpieces.

The transport device is preferably constructed as an inclined transport device, in particular with an adjustable transport direction. A transport device of this type can be used flexibly in order to fulfill different transport and intermediate storage tasks.

The panel separation device is advantageously constructed as a panel removal pivoting gripper. In this case, the control of the panel removal pivoting gripper can be coupled to the control system of the transport device, so that, if appropriate, removal of panels at a constant cycle rate by means of the panel separation device is possible.

Further advantages of the invention emerge from the description.

### BRIEF DESCRIPTION OF THE DRAWINGS

The invention will be explained in more detail by using a preferred exemplary embodiment and with reference to a schematic drawing, in which:

FIG. 1 shows a schematic front view in a perspective illustration of a transport device according to the invention with a single bodywork panel at a panel removal station;

FIG. 2 shows a further schematic front view in a perspective illustration of the transport device of FIG. 1 with a plurality of groups of panels in associated carrier units and

FIG. 3 shows a schematic rear view in a perspective illustration of the transport device of FIG. 1 with a panel removal pivoting gripper.

### DETAILED DESCRIPTION OF THE INVENTION

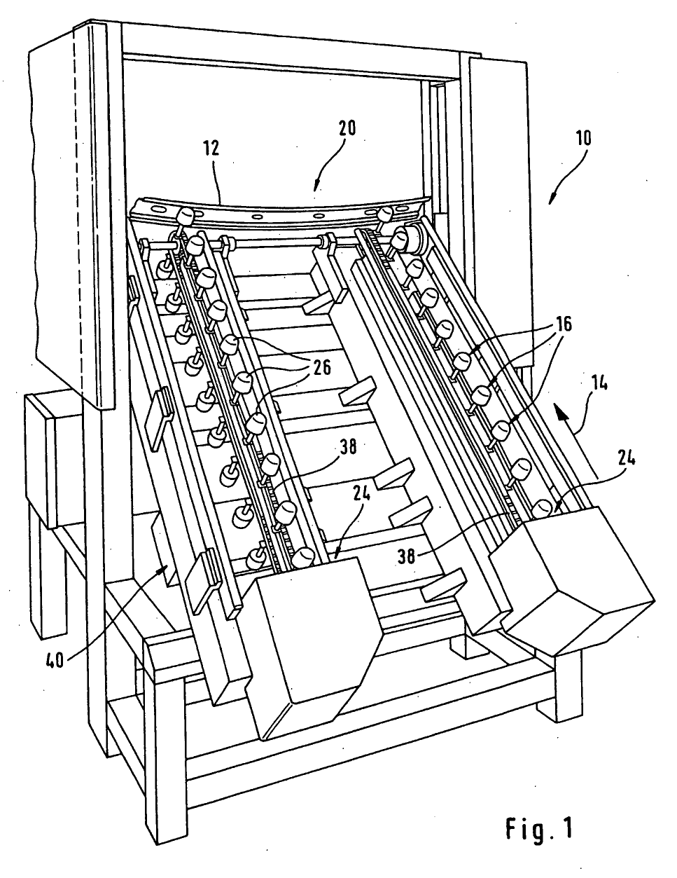

FIG. 1 shows a schematic perspective illustration of a front side of a transport device 10 according to the invention. The transport device 10 is constructed as an inclined transport device and is used for transporting bodywork panels 12 from a panel group formation station 24 in the transport direction 14 to a panel removal station 20. For this purpose, the transport device 10 has a plurality of carrier units 16, which can be moved by means of two endless transport chains 38 in a transport position corresponding to the transport direction 14. Since the transport device 10 is constructed as an endless chain transport device with a suitable loadbearing structure 40, the carrier units 16 are guided back on the underside of the transport device 10 from the panel removal station 20 to the panel group formation station 24 counter to the transport direction 14. Each carrier unit 16 has two associated carrier elements 26 which are arranged in parallel and spaced at intervals from one another and which, in order to form a panel support in the transport position, project outward substantially at right angles to the transport direction 14.

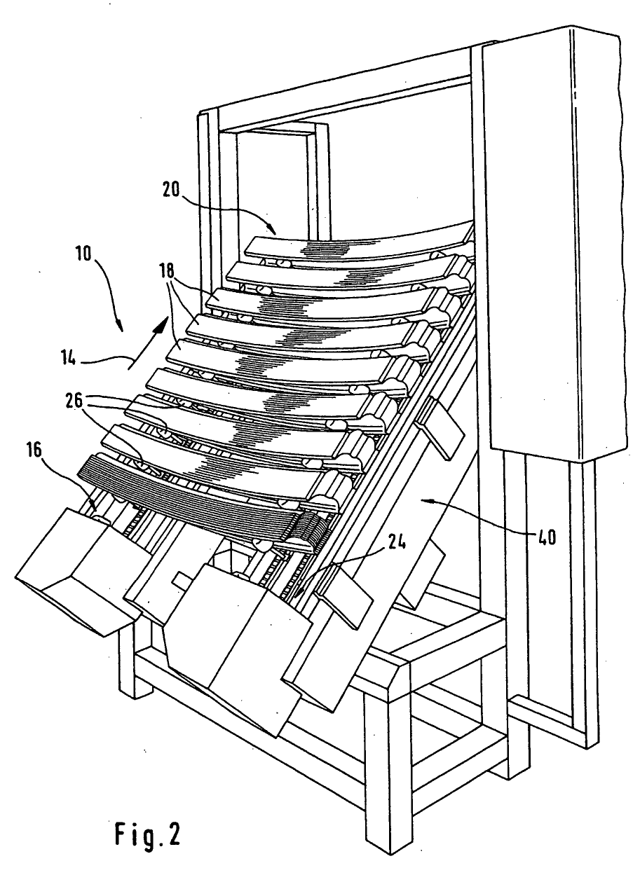

FIG. 2 shows a schematic perspective illustration of a further front view of the transport device 10 of FIG. 1, in each case a group 18 of panels consisting of bodywork panels 12 resting on one another now being arranged in a plurality of the carrier units 16. The carrier unit 16 located at the panel group formation station 24 is still empty according to FIG. 2, that is to say not yet occupied by bodywork panels 12, so that additional bodywork panels 12 can be inserted into this carrier unit 16, for example manually. The respective group 18 of panels is accommodated on edge in the associated carrier unit 16 in such a way that, as viewed in the transport direction 14, the rear bodywork panel 12 rests on the two carrier elements 26 of the carrier unit 16, which are arranged in parallel, and is held securely by the same. The respective group 18 of panels is in this case additionally supported by a supporting unit of the loadbearing structure 40 which is fixed in position, for example in the form of a sliding track, or can be moved in the transport direction 14 in accordance with the transport chain 38. The formation of a respective group 18 of panels at the panel group formation station 24 can in this case be carried out manually or, if appropriate, in an automated manner by means of inserting individual bodywork panels 12 or groups of bodywork panels 12.

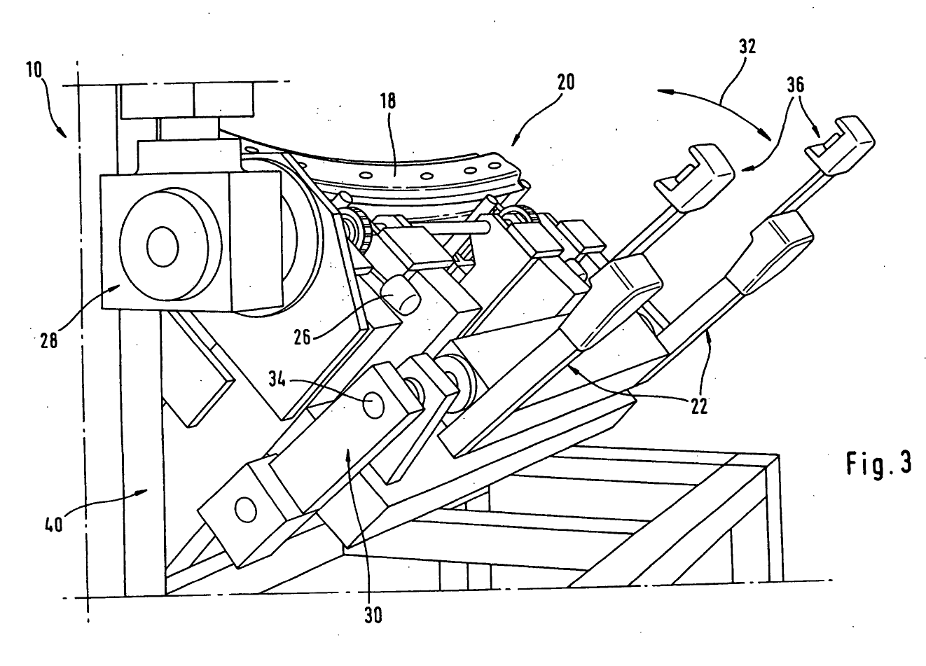

FIG. 3 shows a schematic perspective illustration of a rear view of the transport device of FIG. 1 and, respectively, FIG. 2. The transport device 10 is provided with a panel separation device 22 in the form of a panel removal pivoting gripper. The panel separation device 22 is operated by means of a drive unit 30 and, according to double arrow 32, can be moved about a pivot axis 34 relative to the panel removal station 20 and, respectively, to a panel deposition station, not illustrated. In order to transfer a respective bodywork panel 12 from the panel removal station 20 of the transport device 10 to a panel deposition station of a further station, the panel separation device 22 is provided with a suitable panel gripper system 36. The transport movement of the transport device 10 for positioning a respective group 18 of panels in the panel removal station 20 is triggered under control by means of a drive unit 28.

The position of the carrier elements 26 of the transport device 10 can be adjusted in the transport direction 14 and transversely with respect to the transport direction 14, so that, depending on the geometric shape of the bodywork panels 12, a respective group 18 of panels is held in a defined transport position and in a stable position by the carrier elements 26 of a corresponding carrier unit 16. The loadbearing structure 40 of the transport device 10 can also be adjusted in such a way that a change in the transport direction 14 or, respectively, a correspondingly resulting transport angle of incidence is possible. The transport device 10 is operated in a cyclic manner, the duration of the cycle depending on the panel separation time or on the panel group formation time.

The transport device 10 permits buffering and provision of bodywork panels 12 in relatively large numbers. The stacking height of a respective group 18 of panels depends on the ability of the bodywork panels to be stacked and can be influenced by the number of carrier units 26 provided which have a drive connection to an associated transport chain 38. In order to transport and intermediately store bodywork panels 12 which can be stacked relatively poorly, more carrier elements 26 are thus provided than in the case of bodywork panels 12 which can be stacked relatively well. The transport device 10 permits the use of a considerably improved intermediate storage capacity as compared with traditional transport devices, at the same time the space required for a transport device 10 according to the invention being relatively small. This also results in considerable savings in costs for the operator of the transport device 10.

The further design construction and the further functioning of the transport device 10 are known per se, so that a more detailed description in this regard is dispensed with.

1. A method for transporting bodywork panels (12) of a vehicle by means of an endless transport device (10), equipped with a plurality of carrier units (16) that are spaced at intervals in the transport direction (14), comprising:
stacking an associated group (18) of panels on at least one carrier unit (16),
transporting the group (18) of panels as far as a panel removal station (20) and
in each case removing an individual bodywork panel (12) by a panel separation device (22).

2. The method as claimed in claim 1, wherein the bodywork panels (12) of a respective group (18) of panels are arranged stacked on edge in the carrier unit (16) at a panel group formation station (24).

3. The method as claimed in claim 1, wherein the group (18) of panels in the carrier unit (16) is built up by means of the successive deposition of individual bodywork panels (12).

4. The method as claimed in claim 3, wherein the individual bodywork panels (12) are deposited in the carrier unit (16) manually or in an automated manner, forming the group (18) of panels.

5. The method as claimed in claim 2 wherein the group (18) of panels is transported from the panel group formation station (24) as far as the panel removal station (20) in a transport direction (14) that extends obliquely upward.

6. The method as claimed in claim 1 , wherein the respective group (18) of panels is transported by means of the transport device (10) during a predefinable cycle time, the cycle time depending on the required panel separation time of a complete group (18) of panels respectively located at the panel removal station (20).

7. A transport device (10) for transporting bodywork panels (12) of a vehicle, the transport device (10) being endless and provided with a plurality of carrier units (16) that are spaced at intervals in the transport direction (14), each respective carrier unit (16) having at least one carrier element (26) projecting substantially perpendicular to the transport direction (14), such that:
an associated group (18) of panels can be stacked on at least one carrier unit (16),
the group (18) of panels can be transported as far as a panel removal station (20), and
in each case an individual bodywork panel (12) can be removed by a panel separation device (22) at the panel removal station (20),
wherein the transport device (10) is an inclined transport device.

8. The transport device as claimed in claim 7, wherein the position of the carrier element (26) can be adjusted in the transport direction (14).

9. The transport device as claimed in claim 7, wherein the position of the carrier element (26) can be adjusted transversely with respect to the transport direction (14).

10. The transport device as claimed in claim 7 wherein the number and/or the design construction of the carrier elements (26) used in a carrier unit (16) can be varied as a function of the geometric shape of a bodywork panel (12).

11. The transport device as claimed in claim 7, wherein it is a chain transport device.

12. The transport device as claimed in claim 7 wherein it is an inclined transport device with an adjustable transport direction (14).

13. The transport device as claimed in claim 7 wherein the panel separation device (22) is constructed as a panel removal pivoting gripper.
